(19) United States
(12) Patent Application Publication
(10) Pub. No.: US 2006/0008553 A1
(43) Pub. Date: Jan. 12, 2006

(54) Injection moulding device and a method of opening and closing a partible mould in an injection moulding device

(76) Inventor: Gunnar Dike, Hjarup (SE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/533,551

(22) PCT Filed: Nov. 5, 2003
(86) PCT No.: PCT/SE03/01702

§ 371 Date: May 3, 2005

(30) Foreign Application Priority Data
Nov. 29, 2002 (SE) 0203543-4

(51) Int. Cl. B29C 45/33

(52) U.S. Cl. 425/576

(57) ABSTRACT

A device for forming injection moulded plastic articles comprises a partible mould (5, 7) having an inner mould tool (5) and two outer mould tools (7). The device further comprises a rotatable hub (4) which supports the inner mould tool (5). The inner mould tool (5) is arranged to be moved by the hub (4) in an essentially circular movement into and out of a mould cavity enclosed by the outer mould tools (7). Means (9) for opening and closing the outer mould tools (7) are arranged to move the outer mould tools (7) in a first, radial direction (R) and a second, perpendicular direction (P), moving the outer mould tools (7) so that their central axes (C) coincide throughout the movement. A method of opening and closing a partible mould in an injection moulding device is also disclosed.

### TECHNICAL FIELD OF THE INVENTION

The present invention relates to a device for forming injection moulded plastic articles, comprising a partible mould having an inner mould tool and two outer mould tools, the outer mould tools each having a central axis, the device further comprising a rotatable hub, the inner mould tool being supported by the hub, which is arranged to move the inner mould tool in an essentially circular movement into and out of a mould cavity enclosed by the outer mould tools, and means for opening and closing the outer mould tools around the inner mould tool.

The invention also relates to a method of opening and closing a partible mould in an injection moulding device, the mould comprising an inner mould tool and two outer mould tools, each outer mould tool having a central axis, the device further comprising a rotatable hub, the inner mould tool being supported by the hub.

### BACKGROUND ART

Devices and methods of the above-mentioned kind are known (see e.g. EP-A-862 980) wherein a rotatable mandrel wheel has an inner mould tool arranged at the outer end of each mandrel and wherein an outer mould tool consisting of two outer mould halves is arranged so that the inner mould tools through rotation of the mandrel wheel can be successively moved into and out of the outer mould tool. Each of the outer mould halves is arranged on a pivotable lever which is articulately attached to a part of the support of the injection moulding device and fixedly attached to the outer mould half. In order to open the outer mould tool, the outer mould halves are moved sideways away from the inner mould tool by pivoting the pivotable arms. During the opening movement the outer mould halves are tilted in relation to each other and to their closed position. Devices of this type are used, e.g. for injection moulding plastic tops onto paper sleeves for forming containers. A paper or carton sleeve is placed on one of the mandrels, the mandrel with the sleeve and the inner mould tool is rotated into the outer mould tool. The outer mould tools are closed around the inner mould tool and the end of the sleeve, and a plastic top is moulded onto the end of the sleeve. A problem with this kind of injection moulding device is that it only allows moulding of relatively short or flat plastic tops on the end of the sleeve, since the outer mould halves cannot be moved sufficiently quickly out of the way during opening for allowing the mandrel to pass with a longer or higher plastic part on the end of the sleeve. Another problem is that it may be difficult to align the outer mould halves when closing the outer mould tool.

### SUMMARY OF THE INVENTION

The object of the invention is therefore to provide a device for forming injection moulded plastic articles of essentially the same type as the known device described above, but which allows forming of higher or longer plastic articles.

Another object is to provide a device for forming injection moulded articles allowing improved alignment of the outer mould tools.

Yet another object is to provide a method of opening and closing a partible mould in an injection moulding device, which is quicker than the known methods.

Still another object of the present invention is to provide a method of opening and closing a partible mould which allows higher or longer moulded plastic articles to pass the outer mould tool.

The above-mentioned objects are achieved through a device having the features of appended claim 1, preferred embodiments being defined in claims 2-15. These objects are also achieved by a method according to appended claim 16, variants thereof being defined by dependent claims 17-21.

Thus, in the device of the invention, the means for opening and closing the outer mould tools are arranged to move the outer mould tools in a first direction which is radial in relation to the hub and a second direction which is perpendicular to the first direction and directed in the plane of the circular movement of the inner mould tool, moving the outer mould tools so that their central axes coincide throughout the movement. In this manner, the outer mould tools may quickly be opened and moved away from the inner tools, so that the inner mould tool with a moulded plastic article may pass out of the outer mould tool.

In one embodiment, the means for opening and closing the outer mould tools are arranged to move the outer mould tools in the first and second directions at least partly simultaneously. If each outer mould tool is moved simultaneously in the first and second directions, the opening and closing movements may be speeded up and the means used for opening and closing the outer mould tools may be of a simple construction.

In a specific embodiment, the means for opening and closing the outer mould tools are arranged to move the outer mould tools along circular arcs. This is an effective way of opening and closing the outer mould tools, since they are moved simultaneously in the first and second directions.

The means for opening and closing the outer mould tools may comprise pivotable levers, each lever being articulately attached at one end to an outer mould tool and at the other end to a mounting part of a support for the device. This provides a mechanically simple and reliable means for opening and closing the outer mould tools.

The position of the mounting part is preferably fixed. This improves the accuracy of the control of the movement of the outer mould tools.

The pivoting movement of the pivotable levers may be driven by belt drive means. Thus, the movement of the pivotable levers can be reliably controlled and easily performed.

In one embodiment of the invention, the means for opening and closing the outer mould tools comprise plane guide means for guiding the outer mould tools such that they are aligned when closed. In this way a proper alignment of the outer mould tools can be ensured, which promotes a correct injection moulding process.

The plane guide means may comprise bars on which holders holding the outer mould tools are guided in the second direction. The outer mould tools can thereby easily and reliably be guided in the second direction.

It is preferred that the plane guide means are movable in relation to the mounting part. This makes it easier to guide the outer mould tools in the first direction.

In one embodiment, the belt drive means are parallel with the plane guide means. This allows a simple construction of the device.

In an alternative embodiment, the plane guide means comprise pairs of parallel pivotable levers, each lever being articulately attached at one end to an outer mould tool and at the other end to a mounting part of a support for the device. This provides another mechanically simple, yet reliable way of guiding the outer mould tools.

The device of the invention further preferably comprises radial guide means for guiding the outer mould tools in the first direction. Hereby, the desired movement of the outer mould tools may easily be achieved.

The radial guide means may be arranged to guide the plane guide means in the first direction and thereby guide the outer mould tools in the first direction. This is a simple and reliable way of ensuring the movement of the outer mould tools in the first direction.

In one embodiment, the radial guide means comprise bars on which the plane guide means are guided. This provides a mechanically simple means for guiding the plane guide means.

The device of the invention may further comprise supply means for supplying a plastic material to be injected, the supply means being movable in the first direction with the outer mould tools. In this manner, the position of the supply means in relation to the mould tool may be accurately controlled.

The inventive device further preferably comprises a pressure system for pressurizing the injected plastic material, the pressure system additionally being arranged as an auxiliary means for closing the outer mould tools. This is an efficient way of ensuring the movement of the outer mould tools with a minimum number of components.

In one embodiment, the radial guide means are additionally arranged to guide the supply means. In this manner, the movement of the supply means and the outer mould tools may easily be synchronized.

According to the invention, the device may further comprise means for disengaging the outer mould tools from a frame of the device. Thus, it is possible to disconnect the outer mould tools from the frame in a force sense. As a result, pressure exerted on the outer mould tools during injection of plastic material need not be transmitted to the frame.

In the method of the invention, the outer mould tools are moved in a first direction which is radial in relation to the hub and a second direction which is perpendicular to the first direction and directed in the plane of the circular movement of the inner mould tool, and the outer mould tools are moved so that their central axes coincide throughout the movement. This method ensures that the outer mould tools are opened and closed quickly. It further ensures proper alignment of the outer mould tools when closed.

The outer mould tools are preferably moved in the first and second directions at least partly simultaneously. This makes it possible to speed up the opening and closing of the outer mould tools.

In a preferred variant of the method of the invention, the outer mould tools are moved along circular arcs. In this way the movement in the first and second directions coincide in time, allowing a particularly quick opening and closing of the outer mould tools.

In a variant of the method according to the invention, the outer mould tools are guided on plane guide means in the second direction such that they are aligned when closed. This ensures correctly closed outer mould tools for injection moulding.

The plane guide means are preferably guided on radial guide means in the first direction, whereby the outer mould tools are guided in the first direction. This is an efficient and simple way of guiding the outer mould tools in the first direction.

A supply means for supplying a plastic material to be injected into the partible mould may be moved in the first direction with the outer mould tools. In this way the position of the supply means in relation to the mould tools may be controlled more easily.

In a preferred variant of the inventive method, the outer mould tools are disengaged from a frame of the injection moulding device during injection of the plastic material. Thus, forces exerted on the outer mould tools during injection of plastic material are not transmitted to the frame.

### BRIEF DESCRIPTION OF THE DRAWINGS

The invention will be described in more detail with reference to the appended schematic drawings, which show an example of a currently preferred embodiment of the invention.

FIG. 1 is a perspective view of a machine for injection moulding plastic articles onto the end of sleeves forming containers, including a device according to the invention for forming injection moulded plastic articles.

FIG. 2 is a perspective view of the two mandrel wheels of FIG. 1.

FIG. 3 is a perspective view of a pair of holders for outer mould tools in the device of FIG. 1.

FIG. 4 is a perspective view of two sets of pivotable levers for moving the holders of FIG. 3.

FIG. 5 is a perspective view of belt drive means for driving the movement of the pivotable levers of FIG. 4.

FIG. 6 is a perspective view of an assembly of the holders of FIG. 3, the pivotable levers of FIG. 4 and the belt drive means of FIG. 5.

FIG. 7 is a perspective view of supply means for supplying plastic material for injection in the device of FIG. 1 and guide means for the supply means and the outer mould tools.

FIG. 8 is a perspective view of an assembly of the parts in FIG. 6 and FIG. 7.

FIG. 9 is a perspective view of the holders of FIG. 3 on mould-locking bars in an open position.

FIG. 10 is a perspective view of the holders and mould-locking bars of FIG. 9 in a closed position.

### DESCRIPTION OF A PREFERRED EMBODIMENT OF THE INVENTION

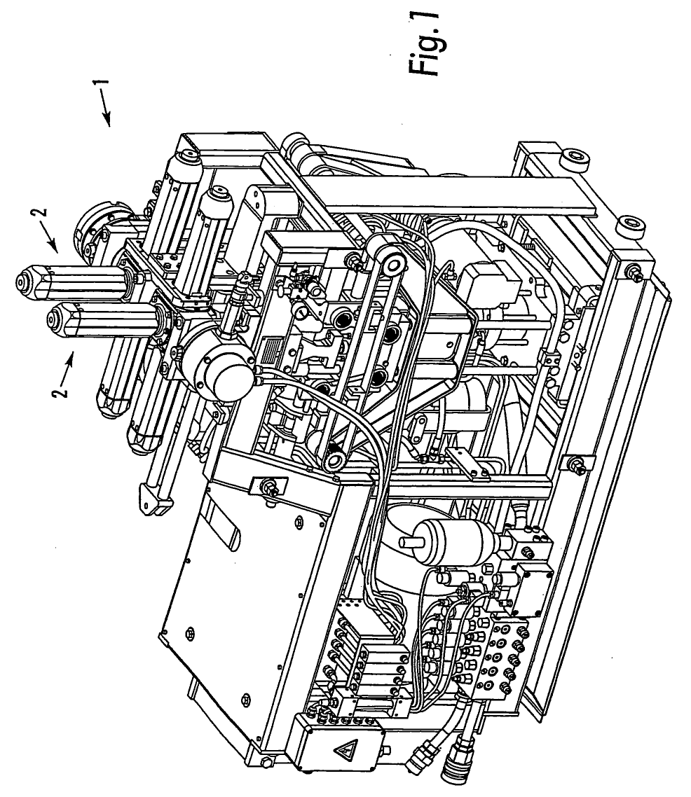

In FIG. 1, an injection moulding machine 1 is shown. Two mandrel wheels 2 can be seen in the top right part of the machine 1.

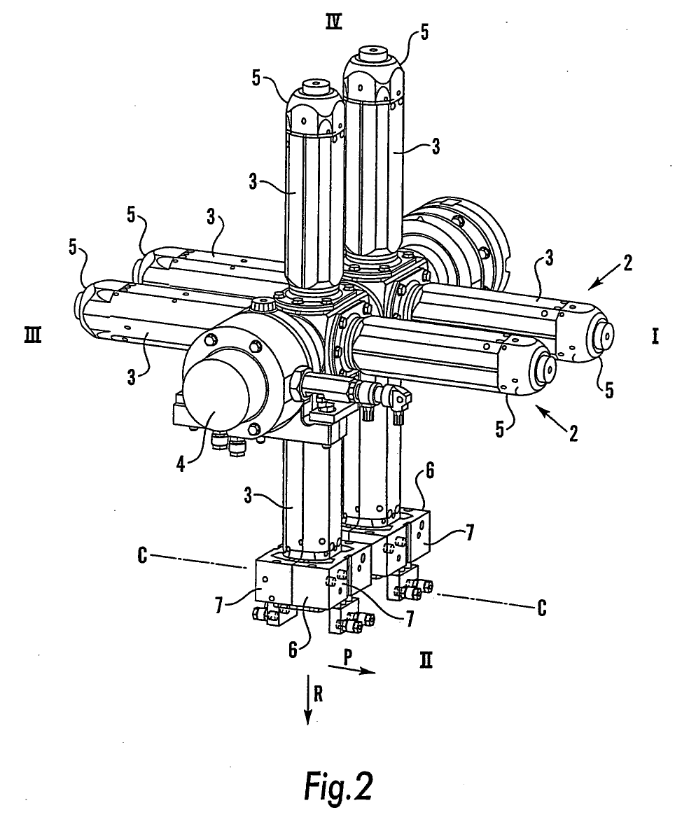

FIG. 2 shows the two mandrel wheels 2, each having four arms or mandrels 3 extending from a central hub 4. At the radially outer end of each mandrel 3 an inner mould 5 tool is formed. An outer mould tool 5 is closed around one of the inner mould tools 5 on each mandrel wheel 2. Each outer mould tool 6 is made up of two outer mould tools or mould tool halves 7, which can be moved apart and towards each other, thus opening and closing around the inner mould tool 5. The mandrel wheel 2 is rotatable through positions I, II, III and IV. Each outer mould tool half 7 has a central axis C which extends in the tangential direction of the rotation of the mandrel wheel 2.

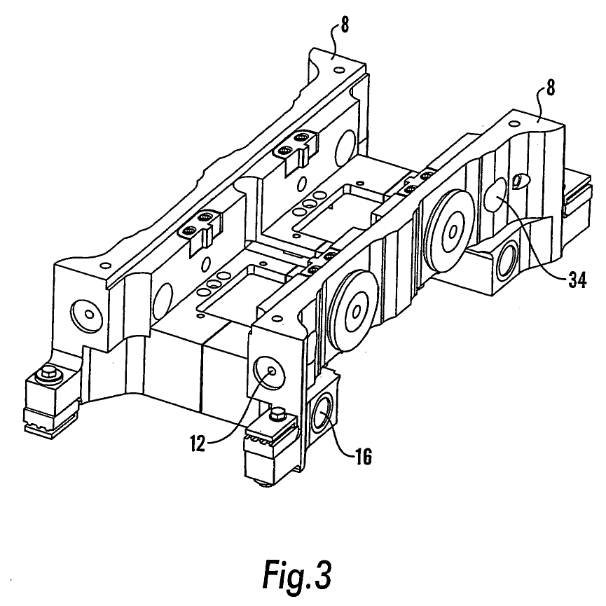

In FIG. 3, a pair of holders 8 for holding the outer mould tool halves 7 are shown.

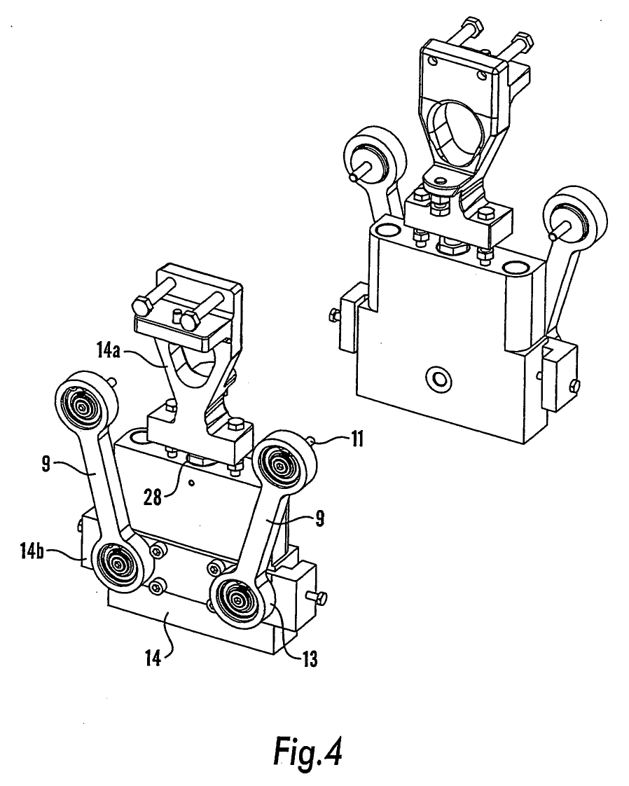

FIG. 4 shows two sets of pivotable levers 9. At one end 10, each lever 9 has a projecting pin 11 for articulate connection to the holder 8 in FIG. 3 by means of a hole 12. At the other end 13, the lever is articulately attached to a fixed mounting part 14 of the support of the machine 1.

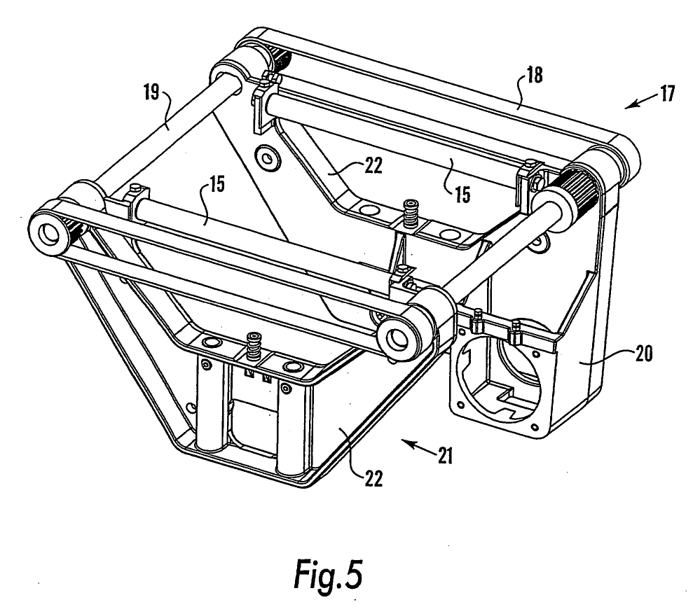

In FIG. 5, guide means (referred to as plane guide means as will be explained below) in the form of horizontal bars 15 for guiding the outer mould tools 7 in the second direction (indicated by arrow P in FIG. 2) can be seen. In the machine 1, the holders 8 of FIG. 3 are attached to the bars 15 by means of holes 16 through which the bars 15 are passed. Further in FIG. 5, belt drive means 17 can be seen, each consisting of a continuous belt 18 driven via two drive shafts 19 connected to a motor (not shown in FIG. 5) which is held in the motor support 20. The arrangement of the bars 15 and drive means 17 is supported on a frame 21 consisting of two yokes 22.

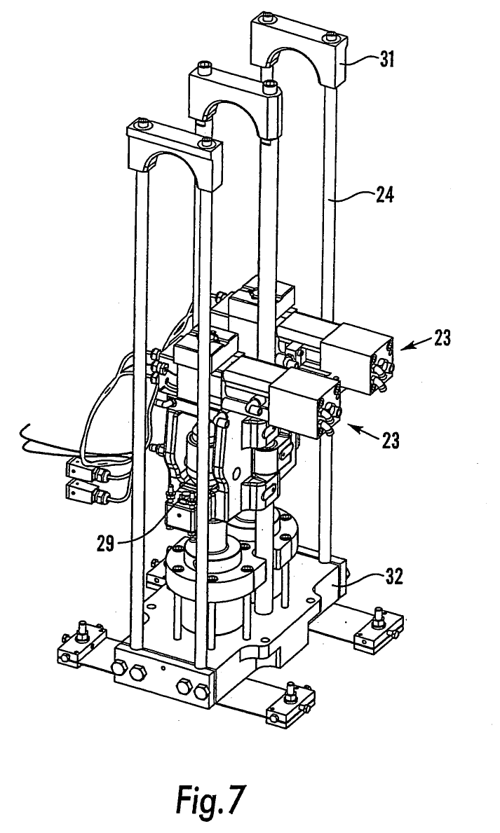

FIG. 7 shows a pair of supply means 23 for supplying plastic material to be injected into the mould formed by the inner mould tool 5 and the outer mould tool 6. Three pairs of vertical bars 24 constitute guide means (referred to as radial guide means as will be explained below) for guiding the outer mould tool halves 7 and the supply means 23 in the first direction (indicated by arrow R in FIG. 2).

The vertical bars 24 guide the outer mould tool halves 7 in the radial direction R of the mandrel wheel 2 and, for the convenience of the discussion, are therefore referred to as radial guide means. In the same way, the horizontal bars 15 guide the outer mould tool halves 7 in the second direction P which is perpendicular to the first, radial direction R and directed in the plane of the circular movement of the mandrels 3, and they are therefore referred to as plane guide means. The designations “radial” and “plane” are in no way intended to limit the possible embodiments of the guide means 15, 24.

A hydraulic cylinder 25 is associated with each supply means 23.

The operation of the machine 1 with its inventive device for forming injection moulded plastic articles will now be described. On each mandrel wheel 2, a paper or carton sleeve (not shown) is placed on one of the mandrels 3 in position I. The mandrel wheel 2 is rotated clockwise, so that the mandrel 3 with the inner mould tool 5 and the sleeve is brought to position II. During the movement of the mandrel 3 into position II, the outer mould tool 6 is open, i.e. the outer mould tool halves 7 are at a distance from each other. When the inner mould tool 5 is in position II, the outer mould tool 6 is closed around the inner mould tool 5, thus creating a mould cavity between the inner and outer mould tools 5, 6. The closing of the outer mould tool 6 is accomplished by means of the pivotable levers 9, which are articulately attached to the holders 8 holding the outer mould tool halves 7 and to the mounting part 14.

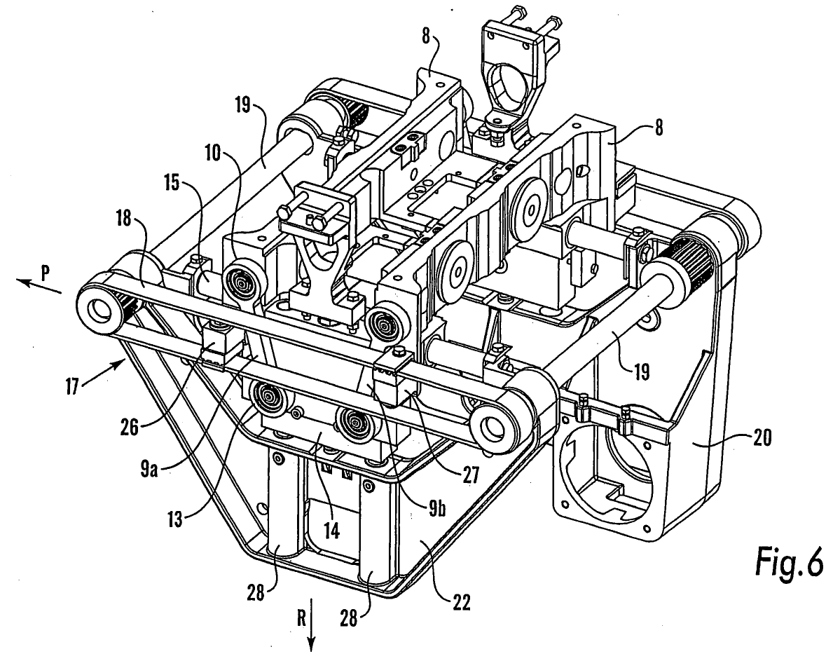

With reference to FIG. 6, the movement of the pivotable levers is controlled and driven by means of the belt drive means 17. A lower block 26 is attached to the lower part of the continuous belt 18 and is connected to the left-hand pivotable lever 9a. An upper block 27 is attached to the upper part of the continuous belt 18 and is connected to the right-hand pivotable lever 9b. The continuous belt 18 is driven via the two drive shafts 19.

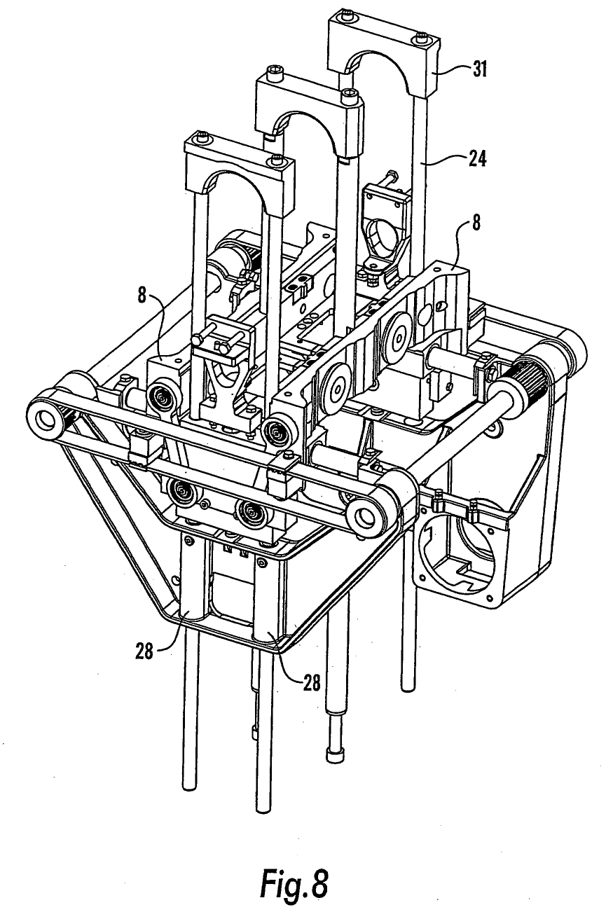

In FIG. 6, the holders 8 are shown in the position where the outer mould tool is closed. If the continuous belt 18 in the foreground of FIG. 6 is driven in the clockwise direction, the blocks 26, 27 are moved away from each other and the levers 9a, 9b are pivoted such that their upper ends 13 are moved outwards, away from each other. Consequently, the holders 8 holding the outer mould tool halves are moved away from each other. By virtue of the articulate attachment of the levers 9 to the holders 8, the holders 8, and thus the outer mould tool halves 7, may be moved away from each other without rotating in relation to each other. Thereby, the central axes C of the outer mould tool halves 7, which, as shown in FIG. 2, coincide when the outer mould tool 6 is closed are kept coinciding throughout the movement. As the holders 8 are moved apart they slide on the horizontal bars 15. In this manner they are kept in alignment. The pivoting movement of the levers 9 move the holders 8 outwards in the horizontal direction P as well as downwards in the vertical direction R. The position of the mounting part 14 is fixed, and therefore the horizontal bars 15 are movable in the vertical direction R. As the pivoting movement of the levers 9 move the holders 8 outwards, the horizontal bars 15 are forced downwards. In each of the yokes 22, there are two parallel, vertical channels 28 through which, as may be seen in FIG. 8, the vertical bars 24 pass. Thus, as the pivoting movement of the levers 9 move the holders 8 apart, the yokes 22 slide downwards along the vertical bars 24, moving the horizontal bars 15, the holders 8 and the outer mould tool halves 7 downwards in the vertical direction R. During the movement, the supply means 23 are moved downwards with the yokes 22, the horizontal bars 15, the holders 8 and the outer mould tool halves 7.

When the outer mould tool 6 is to be closed, the continuous belt 18 is rotated a distance in the counter clockwise direction. The blocks 26, 27 urge the upper ends 10 of the levers 9 towards each other. Thus, the holders 8 are moved towards each other, sliding on the horizontal bars 15, the holders 8 and outer mould tool halves 7 being held with their central axes C coinciding throughout the movement. While the holders 8 slide towards each other during the pivoting movement of the levers 9, the yokes 22 holding the horizontal bars 15, holders 8 and outer mould tool halves 7 slide upwards along the vertical bars. Thus, the outer mould tool halves 7 are brought together in correct alignment, eventually forming a mould cavity with the inner mould tool 5.

The hydraulic cylinder 25 of the supply means 23 is used for pressurizing the plastic material to be injected into the mould formed by the inner mould tool 5 and outer mould tool 6. The hydraulic cylinder 25 also forms part of an auxiliary system for assisting in the closing of the outer mould tool 6. When the outer mould tool 6 is fully open, the holders 8 are as far apart as possible on the horizontal bars 15, and the yokes 22 are in their lowest position on the vertical bars 24. Thus, in order to close the outer mould tool 6, the frictional forces acting along the vertical bars 24 and the horizontal bars 15 have to be overcome as well as the gravitational force acting on the entire arrangement. Therefore, the hydraulic cylinders 25 associated with the plastics supply means 23 are used for assisting the motor in moving the yokes 22 upwards along the vertical bars 24 and the holders 8 inwards along the horizontal bars 15. Since the pressure normally used for pressurizing the plastic material to be injected is much higher (on the order of 100 bar) than the pressure needed to move the mould tool arrangement (on the order of 10 bar), the cylinders 25 are driven not via the normal pressurizing system when working as an auxiliary means for opening and closing the outer mould tool 6, but via a pressure accumulator (not shown). The accumulator is divided by a membrane into an upper and a lower compartment. The upper compartment is filled with gas and the lower compartment is filled with hydraulic oil and connected to the hydraulic cylinder 25. As the mould tool arrangement is moved downwards during opening of the outer mould tool halves 7, the piston of the cylinder 25 is moved downwards and oil is pushed into the accumulator, thus pressurizing the gas in the upper compartment. For closing the outer mould tool halves 7, the pressure in the gas in the upper compartment of the accumulator is used for assisting the motor in moving the yokes 22 upwards along the vertical bars 24 against the gravitational and frictional forces.

It is desirable not to transmit the high pressure that is applied on the mould tool during injection of plastic material to the frame of the injection moulding device. Therefore, the mould tool 5, 6 is disengaged from the frame by means of distance cylinders 28 on the mounting part 14. During opening and closing of the outer mould tool 6, when the entire mould tool package is moving downwards and upwards, the distance cylinders 28 are pressurised. When the outer mould tool 6 is closed before injection of the plastic material, the distance cylinders 28 are depressurised and thus the upper part 14a of the mounting part 14 is disconnected from the lower part 14b in a force transmission sense.

The supply means 23 are also provided with distance cylinders 29. During opening and closing of the outer mould tool 6, as the supply means 23 move vertically with the outer mould tool 6, the distance cylinders 29 are pressurised and thus the supply means are kept at a distance of approximately 0.5 mm from the outer mould tool 6 throughout the movement for preventing scratching of surfaces of contact between the outer mould tool halves 7 and the supply means 23. When the outer mould tool 6 is closed before injection of plastic material, the distance cylinders 29 are depressurised and the supply means 23 are free to move into contact with the outer mould tool halves 7. Thus, plastic material may be delivered by the supply means into the mould and forces forcing the plastic material into the mould may be transmitted.

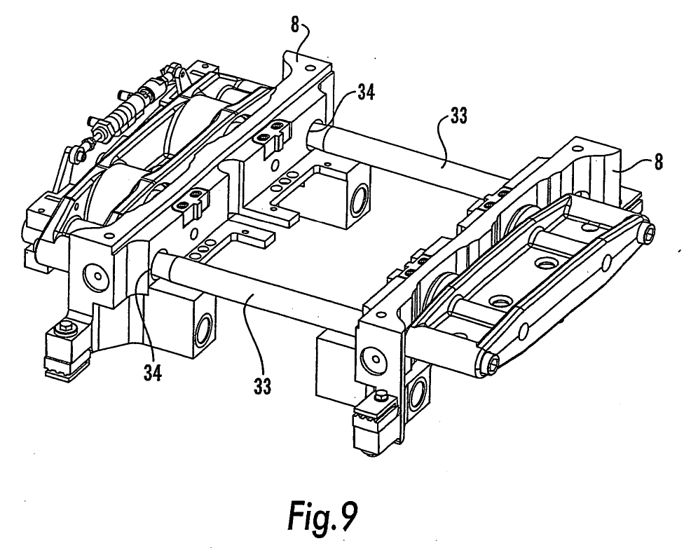

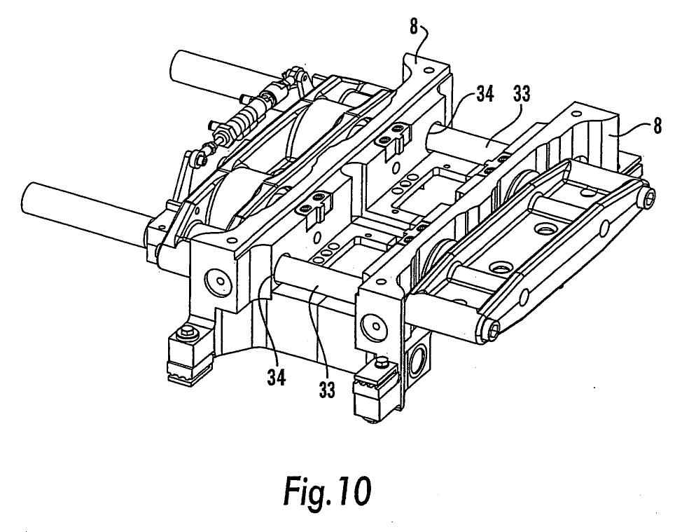

As shown in FIGS. 9 and 10, vertical mould-locking bars 33 pass through holes 34 in the tool holders 8. The mould-locking bars 33 are used for exerting pressure on the outer mould tool halves 7 during injection of plastic material into the mould formed by the inner and outer mould tools 5, 6.

Since during injection the outer mould tools 6, via the lower part 14b of the mounting part 14, are disengaged from the frame of the device 1, the pressure added on the mould tool 5,6 is not transmitted to the frame of the device 1, but via U-shaped links 32 arranged at the top end of the vertical bars 24, each linking two vertical bars 24, to the base plate 32 of the supply means 24.

With the device and method described above, it is ensured that the outer mould tool halves 7 are in correct alignment when closed, so that the forming of injection moulded articles may be accurately performed. The fact that the outer mould tool halves are kept with their central axes C coinciding throughout the opening and closing minimizes the risk of the outer mould tool halves being in misalignment when closed.

The skilled person will realise that a number of modifications of the embodiment of the invention described herein are possible within the scope of the invention as defined by the appended claims.

For instance, whilst in the device described above, the movement of the outer mould tool halves 6 is performed simultaneously in the first, radial direction R and the second, plane direction P, i.e. along circular arcs, other motion patterns are also possible. However, for the speed of the movement it is advantageous to make the movement in the first and second directions at least partly coincide in time. It is also possible, though, to perform the movements in the first and second directions sequentially. The main concern is that the opening and closing of the outer mould tool halves 7 should be quick enough not to slow down the process of producing injection moulded plastic articles.

Instead of the horizontal bars 15, the plane guide means may comprise an additional lever arranged in parallel with each lever 9. Each additional lever is at one end pivotally attached to the mounting part 14 and at the other end to one of the holders 8. In this manner, a parallel pair of levers 9 at each end of the holders 8 move the outer mould tool halves 7 in the opening and closing movement. Since the distance between the levers 9 in each pair is fixed, the pivoting movement of the levers 9 forces the yokes 22 downwards along the vertical bars 24, moving the holders 8 and the outer mould tool halves 7 downwards in the vertical direction R.

1. A device for forming injection moulded plastic articles, comprising a partible mould having an inner mould tool and two outer mould tools, the outer mould tools each having a central axis, the device further comprising a rotatable hub, the inner mould tool being supported by the hub, which is arranged to move the inner mould tool in an essentially circular movement into and out of a mould cavity enclosed by the outer mould tools, and means for opening and closing the outer mould tools around the inner mould tool, characterised in that wherein the means for opening and closing the outer mould tools are arranged to move the outer mould tools in a first direction which is radial in relation to the hub and a second direction which is perpendicular to the first direction and directed in the plane of the circular movement of the inner mould tool, moving the outer mould tools so that their central axes coincide throughout the movement.

2. A device as claimed in claim 1, wherein the means for opening and closing the outer mould tools are arranged to move the outer mould tools in the first and second directions at least partly simultaneously.

3. A device as claimed in claim 2, wherein the means for opening and closing the outer mould tools are arranged to move the outer mould tools along circular arcs.

4. A device as claimed in claim 1, wherein the means for opening and closing the outer mould tools comprise pivotable levers, each lever being articulately attached at one end to an outer mould tool and at the other end to a mounting part of a support for the device.

5. A device as claimed in claim 4, wherein the position of the mounting part is fixed.

6. A device as claimed in claim 4, wherein the pivoting movement of the pivotable levers is driven by belt drive means.

7. A device as claimed in claim 1, wherein the means for opening and closing the outer mould tools comprise plane guide means for guiding the outer mould tools such that they are aligned when closed.

8. A device as claimed in claim 7, wherein the plane guide means comprise bars on which holders holding the outer mould tools are guided in the second direction.

9. A device as claimed in claim 7, wherein the plane guide means are movable in relation to the mounting part.

10. A device as claimed in claim 7, wherein the belt drive means are parallel with the plane guide means.

11. A device as claimed in claim 7, wherein the plane guide means comprise pairs of parallel pivotable levers, each lever being articulately attached at one end to an outer mould tool and at the other end to a mounting part of a support for the device.

12. A device as claimed in claim 7, further comprising radial guide means for guiding the outer mould tools in the first direction.

13. A device as claimed in claim 12, wherein the radial guide means are arranged to guide the plane guide means in the first direction and thereby guide the outer mould tools in the first direction.

14. A device as claimed in claim 13, wherein the radial guide means comprise bars on which the plane guide means are guided.

15. A device as claimed in claim 1, further comprising supply means for supplying a plastic material to be injected, the supply means being movable in the first direction with the outer mould tools.

16. A device as claimed in claim 15, further comprising a pressure system for pressurizing the injected plastic material, the pressure system additionally being arranged as an auxiliary means for closing the outer mould tools.

17. A device as claimed in claim 15, wherein the radial guide means additionally are arranged to guide the supply means.

18. A device as claimed in claim 1, further comprising means for disengaging the outer mould tools from a frame of the device.

19. A method of opening and closing a partible mould in an injection moulding device, the mould comprising an inner mould tool and two outer mould tools, each outer mould tool having a central axis, the device further comprising a rotatable hub, the inner mould tool being supported by the hub, characterised in that the method comprising moving the outer mould tools are moved in a first direction which is radial in relation to the hub and a second direction which is perpendicular to the first direction and directed in the plane of the circular movement of the inner mould tool, with the outer mould tools are moved so that their central axes coincide throughout the movement.

20. A method as claimed in claim 19, wherein the outer mould tools are moved in the first and second directions at least partly simultaneously.

21. A method as claimed in claim 20, wherein the outer mould tools are moved along circular arcs.

22. A method as claimed in claim 19, wherein the outer mould tools are guided on plane guide means in the second direction such that they are aligned when closed

23. A method as claimed in claim 22, wherein the plane guide means are guided on radial guide means in the first direction, whereby the outer mould tools are guided in the first direction.

24. A method as claimed in claim 23, wherein supply means for supplying a plastic material to be injected into the partible mould are moved in the first direction with the outer mould tools.

25. A method as claimed in claim 19, wherein the outer mould tools are disengaged from a frame of the injection moulding device during injection of the plastic material.
